(19) United States
(12) Patent Application Publication
(10) Pub. No.: US 2013/0185969 A1
(43) Pub. Date: Jul. 25, 2013

(54) MOUNTING CLIP FOR MOUNTING A BANNER TO AN APPARATUS FOR RAISING AND LOWERING A BANNER

(71) Applicants: Paul J. Britten, Traverse City, MI (US); Dale A. Troppman, Traverse City, MI (US)

(72) Inventors: Paul J. Britten, Traverse City, MI (US); Dale A. Troppman, Traverse City, MI (US)

(21) Appl. No.: 13/557,276

(22) Filed: Jul. 25, 2012

Related U.S. Application Data
(60) Provisional application No. 61/513,000, filed on Jul. 29, 2011.

(51) Int. Cl. F16B 2/10; G09F 17/00; F16M 13/02

(52) U.S. Cl. CPC F16B 2/10; F16M 13/022; G09F 17/00
USPC 40/584; 24/489; 248/329

(57) ABSTRACT

A clip for securing a banner to a banner mounting rail of apparatus for raising and lowering a banner in accordance with the invention includes a clamshell housing having two halves hinged together at one side of each housing half. One of the housing halves has at least one pin extending outwardly therefrom and the other of the housing halves having a receptacle in which the pin is received when the housing halves are closed together, wherein the pin pierces a banner received between the two housing halves when the two housing halves are closed together. An apparatus for raising and lowering the banner includes a housing, at least one cable secured to the rail, and a motor that winds and unwinds the cable on a tube arranged within the housing. The banner has a plurality of clips secured to the banner with the clips received in the inner channel of the rail.

### CROSS REFERENCE TO RELATED APPLICATIONS

This application claims the benefit of U.S. Provisional Application No. 61/513,000, filed on Jul. 29, 2011. The entire disclosure of the above application is incorporated herein by reference.

### FIELD OF THE INVENTION

The present invention relates to an apparatus for raising and lowering banners that are hung from high places, such as ceilings in malls, and more particularly, to a mounting clip for mounting the banner to the apparatus.

### BACKGROUND OF THE INVENTION

Banners, posters or other types of display articles are used for textual and/or graphical displays. They are hung in a variety of different places and locations. In one type of application, the display article is hung from a high location, such as the ceiling of a mall or other large facility. A motor driven apparatus may be used to raise and lower the display article. One such apparatus is disclosed in U.S. Pat. No. 7,234,685 for “Apparatus for Raising and Lowering a Banner,” the entire disclosure of which is incorporated herein by reference. This apparatus includes a tube, a motor coupled to the tube, and a plurality of cables that are wound and unwound on the tube by the rotation of the tube by a motor. The cables are attached to the top edge of the display article.

More specifically referring to FIGS. 1 and 2 (which are FIGS. 1 and 2 of U.S. Pat. No. 7,234,685), an apparatus 100 for raising and lowering a display article 102 with a retractable power cord assembly is shown. Display article 102 can be any type of article that is hung for display, such as banners, that requires power. With reference to FIGS. 1 and 2, apparatus 100 includes a housing 104, which is illustratively a longitudinally extending channel having a rectangular cross-section, and tube 106. Apparatus 100 may also include mounting brackets 110 which attach to an element 112 of the structure to which apparatus 100 is mounted, such as a rod or beam of a ceiling of a facility such as a shopping mall (not shown). It should be understood that apparatus 100 can be attached to the element 112 in other ways than by mounting brackets 110.

Apparatus 100 further includes one or more lengths of string or cable 114 (which will be collectively referred to as cable 114 herein) having one end secured to tube 106. A top edge 103 of display article 102 is secured to the other end 118 of cable 114 (FIG. 2). In the embodiment of apparatus 100 shown in FIGS. 1 and 2, apparatus 100 includes two lengths of cable 114 secured to tube 106 in spaced relation to each other. Illustratively, the two lengths of cable 114 are preferably spaced from each other a distance that is about equal to or slightly less than the width of the display article 102. It should be understood, however, that apparatus 100 could have other than two lengths of cable 114. Where more than two lengths of cable 114 are used, the lengths of cable 114 may illustratively be spaced equidistantly from each other within the width of the display article. As used herein, the width of the display article 102 is the width of top edge 103 of display article 102 to which cable(s) 114 are attached.

Apparatus 100 also includes a motor assembly 120 to which tube 106 is coupled. Motor assembly 120 is illustratively mounted in housing 104 at a first end 122 (FIG. 2) of housing 104 by attachment to mounting bracket 124, such as with screws 128. Motor 120 may illustratively be a tubular motor, such as a SOMFY LT tubular motor available from SOMFY Systems, 47 Commerce Drive, Cranbury, N.J. 08512. Motor 120 would in such event include a motor 123 to which a tube (not shown) is attached that fits within a first end of tube 106 and to which tube 106 is secured in conventional fashion, such as with screws, rivets, adhesive, welding, or the like (none of which is shown).

Apparatus 100 further includes a second mounting bracket 136 mounted in housing 104 at a second end of housing 104. Tube 106 includes a drive shaft (not shown) that extends from a second end of tube 106 through a hole in second mounting bracket 136 and that has a drive wheel 160 secured to it.

Apparatus 100 further includes cable indexer 164 (FIG. 2) that includes lead screw 166 and traveler(s) 168. A traveler as used herein is an element that moves along housing 104 along an axis parallel to a longitudinal axis of tube 106. Lead screw 166 is journalled for rotation in support bearings 170 that are disposed along a bottom wall 172 of housing 104. Apparatus 100 illustratively has a traveler 168 for each cable 114 attached to display article 102. It should be understood, however, that traveler cable indexer 164 could have a single traveler 168 that works with multiple cables 114.

Each traveler 168 is entrained for movement along bottom wall 172 of housing 104. Illustratively traveler 168 comprises a flat rectangular block. It should be understood that structures other than blocks can be used for traveler 168. Housing 104 may include opposed tracks in which travelers 168 are entrained. Each traveler 168 further includes an aperture 178 therein at one side thereof through which a respective one of cables 114 passes and a threaded member 180, such as a nut, in which lead screw 166 is threadably received. While aperture 178 is shown a hole extending through traveler 168, it should be understood that traveler 168 could include elements affixed to it, such as opposed fingers, that define aperture 178 or in which aperture 178 is formed. Each traveler 168 is disposed in housing 104 so that its aperture 178 is disposed above a slot 181 in bottom wall 172 of housing 104.

Lead screw 166 has a driven wheel 182 secured at an end beneath the drive wheel 160 that is secured to a drive shaft 146. A belt 184 is entrained on wheels 160 and 182. Lead screw 166 is synchronously coupled to tube 106 so that there is no slippage between tube 106 and lead screw 166 when tube 106 rotates to drive lead screw 166 as described below. In the illustrative embodiment described, this synchronization is accomplished by mechanically linking the drive shaft of tube 106 to lead screw 166, such as with toothed wheels 160, 182 and toothed belt 184. It should be understood that tube 106 and lead screw 166 could be synchronized in other ways. By way of example and not of limitation, stepper motors could be used to drive both tube 106 and lead screw 166 and the stepper motors electrically synchronized.

In operation, apparatus 100 raises and lowers display article 102 by winding and unwinding cable(s) 114 on tube 106. Motor 123 of motor assembly 120 rotates tube 106 in the appropriate direction to wind and unwind cable(s) 114 on tube 106. As tube 106 rotates, drive shaft 146 drives lead screw 166 via wheels 160, 182 and belt 184 to rotate lead screw 166. The rotation of lead screw 166 in threaded members 180 of travelers 168 of cable indexer 164 causes travelers 168 to travel longitudinally along the bottom wall 172 of housing 104 and thus longitudinally along tube 106. As cables 114 extend through slots 181 in bottom wall 172 of housing 104 and through apertures 178 of travelers 168 of cable indexer 164, each cable 114 is moved longitudinally along tube 106 as it is being wound on tube 106.

As mentioned, display article 102 may be a banner and can be made from a variety of different materials such as paper, cardboard stock, or a polymeric material such as vinyl or an impact modified polystyrene sheet that may have a thickness of 0.020 inches. With reference to FIGS. 3 and 4, when display article 102 is a banner, cables 114 may be attached to a rail 300. The banner may then have a pole secured to its top edge which is received in an inner channel 302 (FIG. 3) of rail 300. In this regard, when banners are made material such as vinyl that has fabric like characteristics in terms of foldability, a pole pocket is formed in the top edge of the banner, such as by folding over a couple inches of the banner at the top of the banner and stapling or otherwise securing the folded over edge of the banner to the rest of the banner where the folded over edge contacts the rest of the banner. A pole is then inserted in the pole pocket and the pole pocket with the pole therein is inserted into the inner channel 302 of rail 300. A difficulty with this approach is that banners that are displayed in locations such as in shopping malls are sufficiently large that they are typically folded for shipping purposes. If the pole pocket is fabricated prior to shipping the banner to the location where it is to be displayed, the banner may have an “accordion” look when it arrives at the location where it is to be displayed and unfolded from the shipping container.

### SUMMARY OF THE INVENTION

A clip for securing a banner to a banner mounting rail of apparatus for raising and lowering a banner in accordance with the invention includes a clamshell housing having two halves hinged together at one side of each housing half. One of the housing halves has at least one pin extending outwardly therefrom and the other of the housing halves having a receptacle in which the pin is received when the housing halves are closed together, wherein the pin pierces a banner received between the two housing halves when the two housing halves are closed together.

In an aspect, the housing half having the pin includes a plurality of pins and the other housing half includes a receptacle for each of the plurality of pins.

In an aspect, each receptacle is a slot that frictionally engages the corresponding pin that is received in that slot when the two housing halves are closed together to hold the two housing halves together.

In an aspect, the housing has an outer geometry that conforms to an inner geometry of an inner channel of the rail.

In an aspect, an apparatus for raising and lowering the banner includes a housing, at least one cable secured to the rail, and a motor that winds and unwinds the cable on a tube arranged within the housing. The banner has a plurality of clips secured to the banner with the clips received in the inner channel of the rail.

In an aspect, a method of securing a banner to the apparatus for raising and lowering the banner includes closing a plurality of mounting clips over a top edge of the banner so that pins in a first housing half of each of the mounting clips pierce the banner and are received in corresponding slots of a second housing half of the respective mounting clips to hold the banner to the mounting clip and hold the housing halves of the mounting clips together. The mounting clips are then inserted into an inner channel of a rail.

### BRIEF DESCRIPTION OF THE DRAWINGS

The present invention will become more fully understood from the detailed description and the accompanying drawings, wherein:

FIG. 1 is a perspective view of a prior art apparatus in accordance with the disclosure for raising and lowering a display article;

FIG. 2 is a side perspective view, partially broken away, of the apparatus of FIG. 1 taken along the line 2-2 of FIG. 1;

FIG. 3 is a perspective view of a prior art banner mounting rail for use with apparatus of FIG. 1 when the display article is a banner;

FIG. 4 is an end view of the rail of FIG. 3;

FIG. 5 is a perspective view of a mounting clip for a banner in accordance with an aspect of the present invention;

FIG. 6 is a perspective view of the outside of mounting clip of FIG. 5 in an open position;

FIG. 7 is a perspective view of the inside of mounting clip of FIG. 5 in an open position;

FIG. 8 is a sectional view of the mounting clip of FIG. 5 taken along the line 8-8 in FIG. 7; and

FIG. 9 is a side view of a prior art banner.

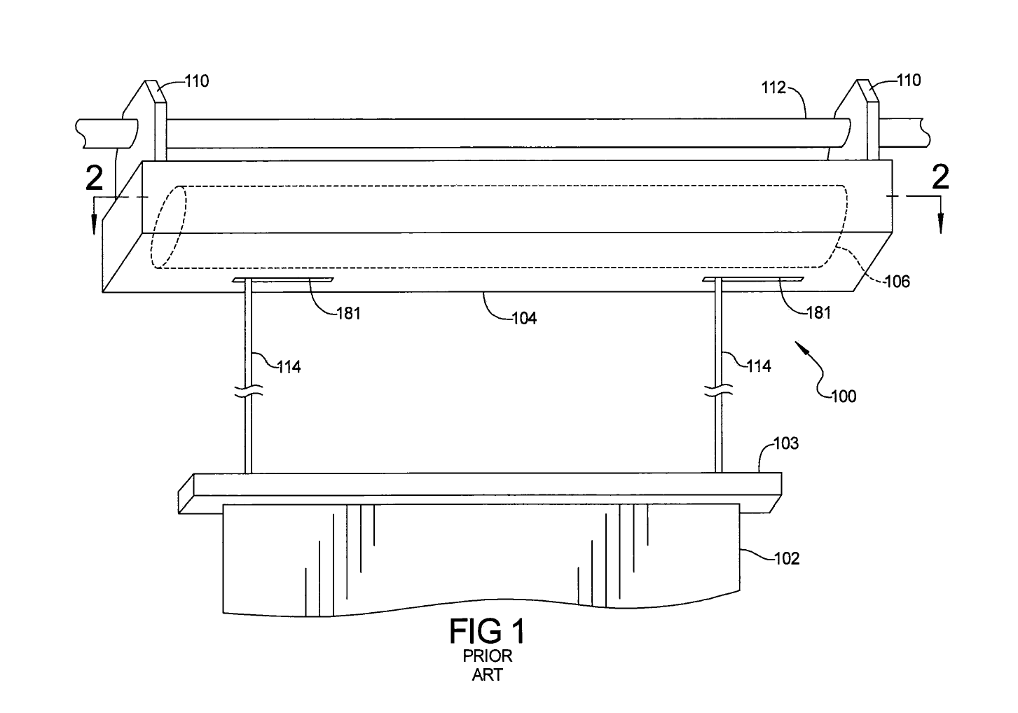

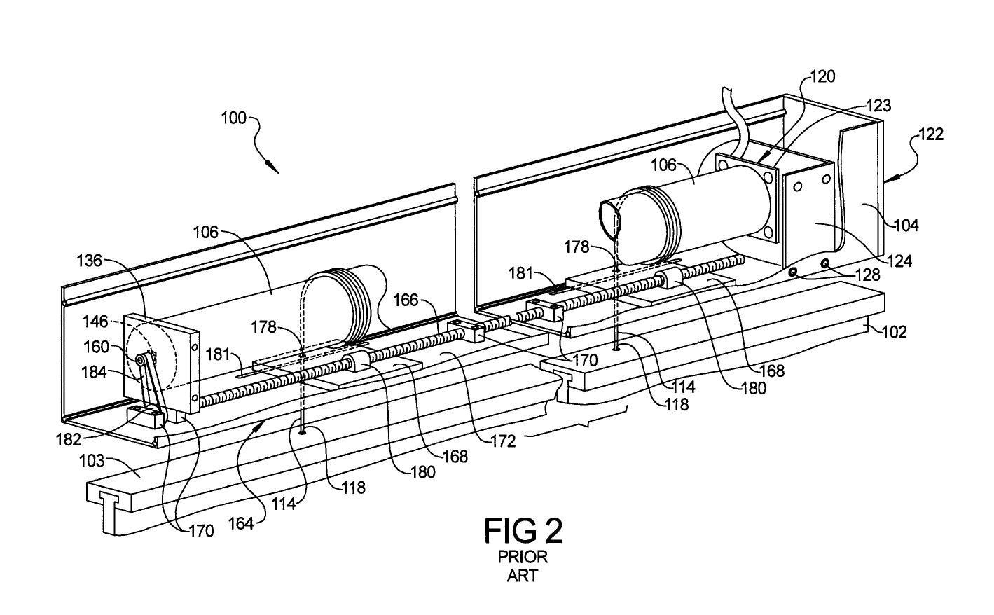

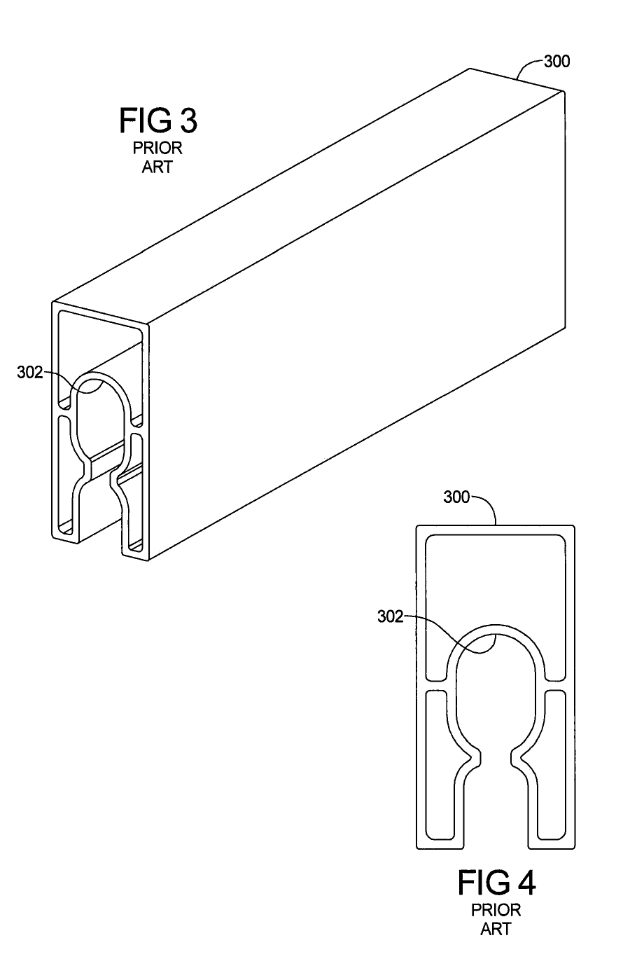

### DETAILED DESCRIPTION OF THE PREFERRED EMBODIMENTS

The following description of the preferred embodiment(s) is merely exemplary in nature and is in no way intended to limit the invention, its application, or uses.

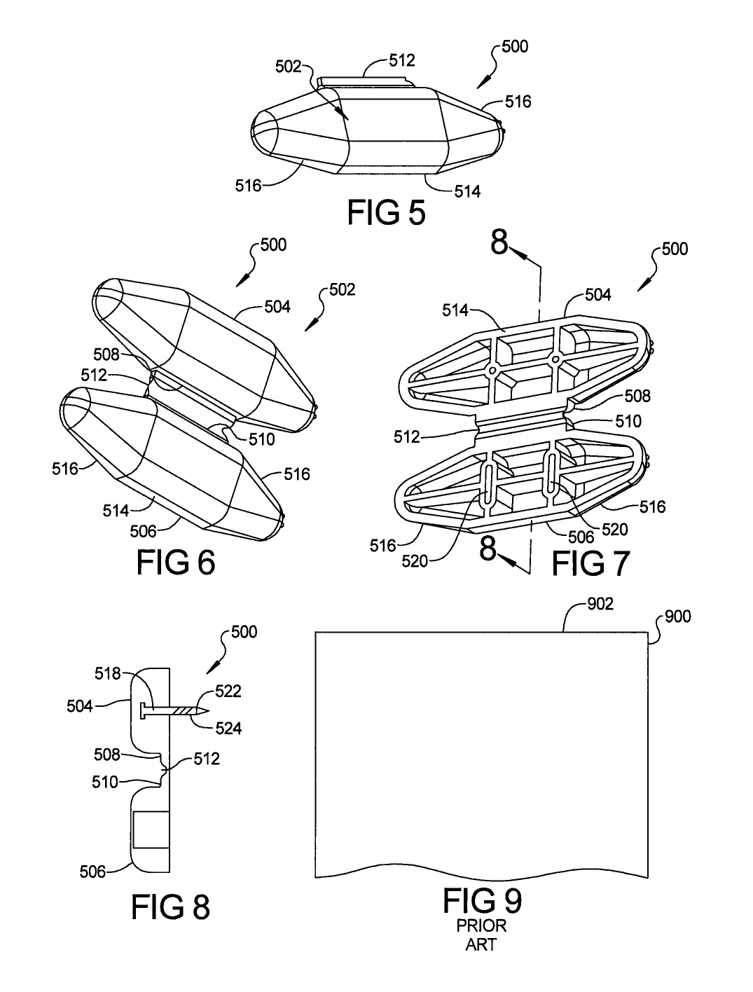

FIGS. 5-8 show a mounting clip 500 for mounting a banner 900 (FIG. 9) to rail 300 of the apparatus 100 for raising and lowering banner 900. In this regard, Mounting clip 500 includes a clamshell housing 502 having two housing halves 504, 506 (FIGS. 6 and 7). Housing halves 504, 506 are hinged together along respective edges 508, 510 by a hinge 512. In an illustrative embodiment, clamshell housing is molded from a polymeric material, such as high density polypropylene, and hinge 512 is a living hinge formed by a thin section of the polymeric material and molded integrally with housing halves 504, 506.

Housing 502 illustratively has a center section 514 having a rectangular cross-section and tapered end sections 516. Housing half 504 illustratively has a plurality of pins 518 (only one of which is shown in FIG. 7) extending outwardly therefrom. In an illustrative embodiment, housing half 504 includes two pins 518. Pins 518 may illustratively be brads that are inserted molded in housing half 504 when housing 502 is molded. A portion 522 of each pin 518 that extends outwardly from housing half 504 may have a roughened or serrated surface 524.

Housing half 506 includes receptacles 520 that receive pins 518 when housing halves 504, 506 are closed together. Receptacles 520 may illustratively be slots. Receptacles 520 are illustratively smaller in one dimension than a diameter of pins 518 so that pins 518 are frictionally engaged by receptacles 520 to hold housing halves 504, 506 together when housing halves 504, 506 are closed together. For example, when receptacles 520 are slots, a width of the slots is slightly smaller than a diameter of pins 518. Roughened surfaces 524 of portions 522 of pins 518 enhance the frictional engagement of pins 518 with receptacles 520.

In an aspect, a plurality of mounting clips are 500 are used to secure banner 900 to rail 300 of apparatus 100. The housing halves 504, 506 of clamshell housing 502 of mounting clips 500 are closed over a top edge 902 of banner 900 so that pins 518 in each housing half 504 of each mounting clip 500 pierce the banner and are received in corresponding receptacles 520 in the corresponding housing half 506 of each mounting clip 500 to hold the banner 900 to the mounting clip 500 and hold the housing halves 504, 506 of the mounting clips 500 together. The mounting clips 500 are then inserted into inner channel 302 of rail 300.

As discussed, banner 900 may be made of a variety of different materials such as paper, cardboard stock, or a polymeric material such as vinyl or an impact modified polystyrene sheet. The polystyrene sheet may by way of example and not of limitation have a thickness of 0.020 inches. In this regard, the housing half 504 of clamshell housing 502 of mounting clip 500 is configured to support pins 518 such that pins 518 can pierce the polystyrene sheet when housing halves 504, 506 are closed over the top edge 902 of banner 900 and support the banner made of polystyrene sheet when the mounting clip is inserted into inner channel 302 of rail 300. Pins 518 are made to have sufficient strength that they can pierce the polystyrene sheet. In this regard, ½″ long brads are used for pins 518 and have sufficient strength to pierce the impact modified polystyrene sheet having a thickness of 0.020 inches.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A mounting clip for securing a banner to a banner mounting rail of apparatus for raising and lowering a banner, comprising:
a clamshell housing having two halves hinged together at one side of each housing;
one of the housing halves has at least one pin extending outwardly therefrom and the other of the housing halves having a receptacle in which the pin is received when the housing halves are closed together, wherein the pin pierces a banner received between the two housing halves when the two housing halves are closed together.

2. The mounting clip of claim 1 wherein the housing half having the pin includes a plurality of pins and the other housing half includes a receptacle for each of the plurality of pins.

3. The mounting clip of claim 2 wherein each receptacle is a slot that frictionally engages the pin that is received in that slot when the two housing halves are closed together to hold the two housing halves together.

4. The mounting clip of claim 2 wherein the housing has an outer geometry that conforms to an inner geometry of an inner channel of the rail.

5. An apparatus for raising and lowering the banner includes a housing, at least one cable secured to the rail, and a motor that winds and unwinds the cable on a tube arranged within the housing, the improvement comprising a plurality of mounting clips secured to the banner with the clips received in the inner channel of the rail.

6. The apparatus of claim 5, wherein each mounting clip includes:
a clamshell housing having two housing halves hinged together at one side of each housing;
one of the clamshell housing halves has at least one pin extending outwardly therefrom and the other of the clamshell housing halves having a receptacle in which the pin is received when the clamshell housing halves are closed together, wherein the pin pierces a banner received between the two clamshell housing halves when the two clamshell housing halves are closed together.

7. The apparatus of claim 6 wherein the clamshell housing half having the pin includes a plurality of pins and the other clamshell housing half includes a receptacle for each of the plurality of pins.

8. The apparatus of claim 7 wherein each receptacle is a slot that frictionally engages the pin that is received in that slot when the two clamshell housing halves are closed together to hold the two clamshell housing halves together.

9. The apparatus of claim 8 wherein the banner is made of a polymeric material.

10. The apparatus of claim 9 wherein the banner is made of vinyl.

11. The apparatus of claim 9 wherein the banner is made of an impact modified polystyrene sheet.

12. The apparatus of claim 11 wherein the impact modified polystyrene sheet has a thickness of 0.020 inches.

13. The apparatus of claim 5 wherein the clamshell housing has an outer geometry that conforms to an inner geometry of an inner channel of the rail.

14. In an apparatus for raising and lowering the banner includes a housing, at least one cable secured to the rail, and a motor that winds and unwinds the cable on a tube arranged within the housing, a method of securing the banner to the rail, comprising:
closing housing halves of a plurality of mounting clips over a top edge of the banner to pierce the banner with pins extending from one of the housing halves of each of the housing halves;
receiving the pins in receptacles in the other housing halves of each of the mounting clips to secure the banner to the mounting clips and hold the housing halves of the mounting clips together; and
inserting the mounting clips in an inner channel of the rail.
